(19) United States
(12) Patent Application Publication
(10) Pub. No.: US 2023/0351337 A1
(43) Pub. Date: Nov. 2, 2023

(54) GENERATING AND SECURING DIGITAL CHECKS USING DISTRIBUTED LEDGER AND EMBEDDED CHIP METHODS

(71) Applicant: Bank of America Corporation, Charlotte, NC (US)

(72) Inventors: George Albero, Charlotte, NC (US); Maharaj Mukherjee, Poughkeepsie, NY (US); Benjamin D. Moores, Ventura, CA (US)

(21) Appl. No.: 17/733,069

(22) Filed: Apr. 29, 2022

(51) Int. Cl. G06Q 20/04; G06Q 20/10; G06Q 20/40; G06Q 20/38

(52) U.S. Cl. CPC G06Q 20/0425; G06Q 20/108; G06Q 20/40145; G06Q 20/3825; G06Q 2220/00

(57) ABSTRACT

Aspects of the disclosure relate to digital check generation. A computing platform may receive, from a first user device, a digital check generation request, requesting a transfer of funds from an account of a first individual to an account of a second individual. The computing platform may generate, based on the digital check generation request, a first digital check, which may be traceable and configured for cancellation by the first individual prior to deposit. The computing platform may record the first digital check to a distributed ledger. The computing platform may send, to a second user device, a notification of the first digital check. The computing platform may receive, from the second user device, a check processing request requesting one of: a transfer of the first digital check, a deposit of the first digital check, or generation of a second digital check, and may proceed accordingly.

### BACKGROUND

Aspects of the disclosure relate to computer hardware and software for event processing. In some instances, individuals may use enterprise applications (such as mobile banking applications) to perform events such as depositing checks. For example, the application may be used to capture an image of the check, and may process the check for deposit into the individual's account accordingly. In some instances, the use of checks may provide security benefits over other methods of performing electronic funds transfers. As mobile applications are increasingly used for check processing, it may be important to expand the functionality of such applications to increase client convenience, while maintaining the security parameters offered by traditional methods of providing such functions, without the need to capture an image of a physical check.

### SUMMARY

Aspects of the disclosure provide effective, efficient, scalable, and convenient technical solutions that address and overcome the technical problems associated with digital check generation. In accordance with one or more embodiments of the disclosure, a computing platform comprising at least one processor, a communication interface, and memory storing computer-readable instructions may receive, from a first user device, a digital check generation request, requesting a transfer of funds from an account of a first individual to an account of a second individual. The computing platform may generate, based on the digital check generation request, a first digital check, which may be traceable and configured for cancellation by the first individual prior to deposit. The computing platform may record the first digital check to a distributed ledger. The computing platform may send, to a second user device, a notification of the first digital check. The computing platform may receive, from the second user device, a check processing request requesting one of: a transfer of the first digital check, a deposit of the first digital check, or generation of a second digital check. Based on receiving a request to deposit the first digital check, the computing platform may send, to an event processing system, one or more commands directing the event processing system to transfer the funds from the account of the first individual to the account of the second individual, which may cause the event processing system to transfer the funds from the account of the first individual to the account of the second individual. Based on receiving a request to transfer the first digital check, the computing platform may: 1) configure the first digital check for transfer, which may include redacting information of the first individual from the first digital check and adding a third individual as a recipient of the first digital check, and 2) send, to a third user device of the third individual, a notification of the transfer of the first digital check. Based on receiving a request to generate a second digital check, the computing platform may: 1) generate a second digital check, configured to transfer a different amount of funds, from the account of the second individual to the account of the third individual, 2) send, to the third user device, a notification of the second digital check, and 3) based on receiving a request to deposit the second digital check, send, to the event processing system, one or more commands directing the event processing system to transfer the different amount of funds from the account of the first individual to the account of the third individual, which may cause the event processing system to transfer the different amount of funds from the account of the first individual to the account of the third individual.

In one or more instances, the computing platform may generate the first digital check by validating that an amount of funds in the account of the first individual is equal to or greater than the funds of the first digital check, and based on successfully validating that the amount of funds in the account of the first individual is equal to or greater than the funds of the first digital check, embedding, in the first digital check, a digital chip indicating that the first digital check is validated. In one or more instances, receiving the check processing request may include receiving endorsement information of the second individual, which may include one or more of: results of a retina scan, a fingerprint, a faceprint, a digital signature, or a multi-factor authentication input.

In one or more examples, receiving the request to generate the second digital check may include a request to generate a check for a higher amount of funds than the first digital check, and generating the second digital check may be based on the funds of the first digital check and funds of one or more accounts of the second individual. In one or more examples, the one or more accounts of the second individual may be pre-selected.

In one or more instances, the computing platform may identify that a balance of an initially selected account of the one or more accounts of the second individual is equal to a preset minimum balance for the initially selected account. Based on determining that the balance of the initially selected account of the one or more accounts of the second individual is equal to the preset minimum balance for the initially selected account, the computing platform may generate the second digital check based on funds from a different selected account of the one or more accounts of the second individual.

In one or more examples, generating the second digital check based on the funds of the first digital check and funds of the one or more accounts of the second individual may include generating the second digital check based on: 1) the funds of the first digital check, 2) an amount of funds of an initially selected account, equal to a difference between a current balance of the initially selected account and a predetermined minimum balance of the initially selected account, and 3) an amount of funds of a subsequently selected account, equal to a difference between the requested amount of funds for the second digital check and a sum of: the funds of the first digital check and the amount of funds of the initially selected account. In one or more instances, receiving the request to generate the second digital check may include a request to generate a check for a lower amount of funds than the first digital check.

In one or more instances, generating the second digital check may include generating a new check, indicating a transfer of the lower amount of funds from the account of the second individual to the account of the third individual, and recording, to the distributed ledger, an updated balance of the first digital check, which may be a difference between the funds of the first digital check and the lower amount of funds. In one or more instances, sending the notification of the first digital check may include granting access permissions, for the second individual, to the distributed ledger.

In one or more examples, the computing platform may receive, from the first user device, a request to cancel the first digital check. Based on identifying that the first digital check has not been deposited, the computing platform may void the first digital check, which may prevent future deposit of the first digital check. In one or more examples, generating the first digital check may include using funds from at least two accounts of the first individual.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing architecture for performing enhanced digital check generation in accordance with one or more example embodiments;

FIGS. 2A-2G depict an illustrative event sequence for performing enhanced digital check generation in accordance with one or more example embodiments;

FIGS. 3-6 depict illustrative graphical user interfaces depicting digital checks in accordance with one or more example embodiments;

FIG. 7 depicts an illustrative method for performing enhanced digital check generation in accordance with one or more example embodiments; and

FIGS. 8 and 9 depict illustrative distributed ledgers for performing enhanced digital check generation in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction of the concepts described in further detail below, there is not currently a method of transferring money in one or multiple accounts to create a secure digital check image for use in payments, transfers, point of sale merchant transactions, and/or other transactions. Accordingly, described herein is a mobile platform that may allow a user to specify how much and from which accounts to pull from to create a secure digital check for use in payments, transfers, point of sale merchant transactions, and/or other transactions. This digital check image may utilize multiple factors to exponentially provide better security than sending cash, while maintaining the speed and in some instances, it may be even faster overall. For example, the system described herein may allow for the selection of multiple amounts from multiple accounts at the same time to create a secure digital check image.

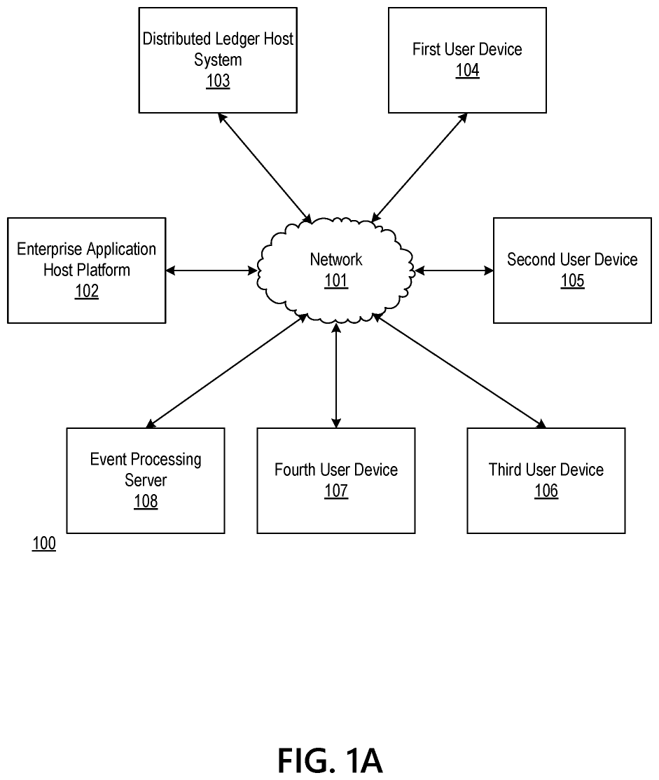

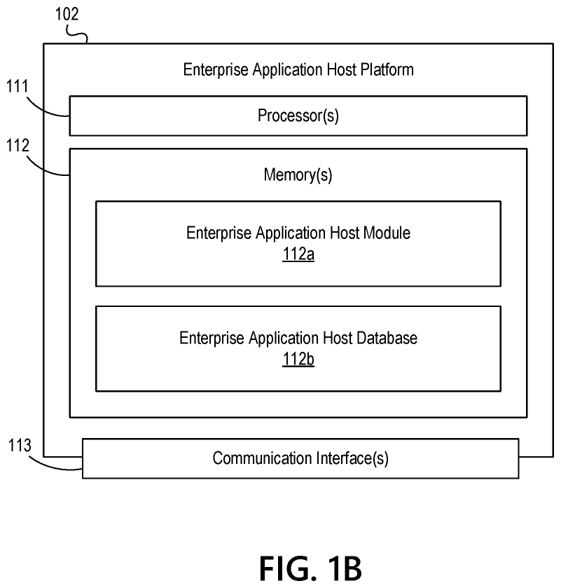

FIGS. 1A-1B depict an illustrative computing environment for performing enhanced digital check generation in accordance with one or more example embodiments. Referring to FIG. 1A, computing environment 100 may include one or more computer systems. For example, computing environment 100 may include enterprise application host platform 102, distributed ledger host system 103, first user device 104, second user device 105, third user device 106, fourth user device 107, and/or event processing server 108.

As described further below, enterprise application host platform 102 may be a computer system that includes one or more computing devices (e.g., servers, server blades, or the like) and/or other computer components (e.g., processors, memories, communication interfaces) that may be used to host an enterprise application (e.g., a mobile banking application) as described further below. In these instances, the enterprise application host platform 102 may be configured to provide or otherwise support one or more application services (e.g., check processing, and/or other services). In some instances, the enterprise application host platform 102 may comprise an independent computing platform. In other instances, the enterprise application host platform 102 may be represented by one or more client device modules integrated into or otherwise stored at various client devices (e.g., first user device 104, second user device 105, third user device 106, fourth user device 107, and/or other user devices).

Distributed ledger host system 103 may be a computer system that includes one or more computing devices (e.g., servers, server blades, or the like) and/or other computer components (e.g., processors, memories, communication interfaces) that may be used to support a distributed ledger (e.g., blockchain, holochain, and/or other distributed ledger). In some instances, the distributed ledger host system 103 may be configured to communicate with the enterprise application host platform 102 to provide check validation and/or otherwise record transactions/events. In some instances, the distributed ledger host system 103 may be an optional system in the network 101.

First user device 104 may be and/or otherwise include a laptop computer, desktop computer, mobile device, tablet, smartphone, and/or other device that may be used by an individual to access a client application (e.g., a mobile banking application, or the like). In some instances, first user device 104 may be configured to display one or more user interfaces (e.g., digital check interfaces, or the like). In some instances, the first user device 104 may correspond to a first user.

Second user device 105 may be and/or otherwise include a laptop computer, desktop computer, mobile device, tablet, smartphone, and/or other device that may be used by an individual to access a client application (e.g., a mobile banking application, or the like). In some instances, second user device 105 may be configured to display one or more user interfaces (e.g., digital check interfaces, or the like). In some instances, the second user device 105 may correspond to a second user, different than the first user.

Third user device 106 may be and/or otherwise include a laptop computer, desktop computer, mobile device, tablet, smartphone, and/or other device that may be used by an individual to access a client application (e.g., a mobile banking application, or the like). In some instances, third user device 106 may be configured to display one or more user interfaces (e.g., digital check interfaces, or the like). In some instances, the third user device 106 may correspond to a third user, different than the first and second users.

Fourth user device 107 may be and/or otherwise include a laptop computer, desktop computer, mobile device, tablet, smartphone, and/or other device that may be used by an individual to access a client application (e.g., a mobile banking application, or the like). In some instances, fourth user device 107 may be configured to display one or more user interfaces (e.g., digital check interfaces, or the like). Although four user devices are shown, any number of user devices may be deployed in the systems/methods described below without departing from the scope of the disclosure. In some instances, the fourth user device 107 may correspond to a fourth user, different than the first, second, or third users.

Event processing server 108 may be a computer system that includes one or more computing devices (e.g., servers, server blades, or the like) and/or other computer components (e.g., processors, memories, communication interfaces) that may be used to process events (e.g., route funds between accounts, execute transactions, and/or otherwise perform enterprise functions). In some instances, the event processing server 108 may be independent from the enterprise application host platform 102, and in other instances, the event processing server 108 may be part of or otherwise integrated into the enterprise application host platform 102.

Computing environment 100 also may include one or more networks, which may interconnect enterprise application host platform 102, distributed ledger host system 103, first user device 104, second user device 105, third user device 106, fourth user device 107, and/or event processing server 108. For example, computing environment 100 may include a network 101 (which may interconnect, e.g., enterprise application host platform 102, distributed ledger host system 103, first user device 104, second user device 105, third user device 106, fourth user device 107, and/or event processing server 108).

In one or more arrangements, enterprise application host platform 102, distributed ledger host system 103, first user device 104, second user device 105, third user device 106, fourth user device 107, and/or event processing server 108 may be any type of computing device capable of sending and/or receiving requests and processing the requests accordingly. For example, enterprise application host platform 102, distributed ledger host system 103, first user device 104, second user device 105, third user device 106, fourth user device 107, event processing server 108, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of enterprise application host platform 102, distributed ledger host system 103, first user device 104, second user device 105, third user device 106, fourth user device 107, and/or event processing server 108 may, in some instances, be special-purpose computing devices configured to perform specific functions.

Referring to FIG. 1B, enterprise application host platform 102 may include one or more processors 111, memory 112, and communication interface 113. A data bus may interconnect processor 111, memory 112, and communication interface 113. Communication interface 113 may be a network interface configured to support communication between enterprise application host platform 102 and one or more networks (e.g., network 101, or the like). Memory 112 may include one or more program modules having instructions that when executed by processor 111 cause enterprise application host platform 102 to perform one or more functions described herein and/or one or more databases that may store and/or otherwise maintain information which may be used by such program modules and/or processor 111. In some instances, the one or more program modules and/or databases may be stored by and/or maintained in different memory units of enterprise application host platform 102 and/or by different computing devices that may form and/or otherwise make up enterprise application host platform 102. For example, memory 112 may have, host, store, and/or include enterprise application host module 112a and/or enterprise application host database 112b.

Enterprise application host module 112a may have instructions that direct and/or cause enterprise application host module 112a to provide enhanced digital check generation, as discussed in greater detail below. Enterprise application host database 112b may store information used by enterprise application host module 112a and/or enterprise application host platform 102 in application of advanced techniques to provide enhanced digital check generation and/or in performing other functions.

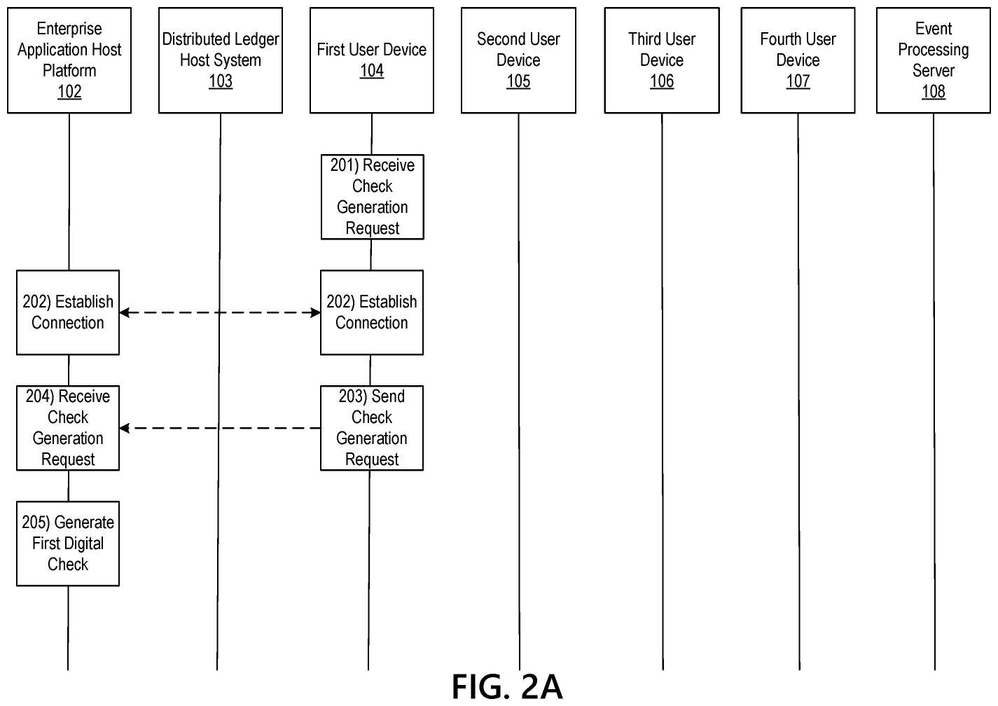

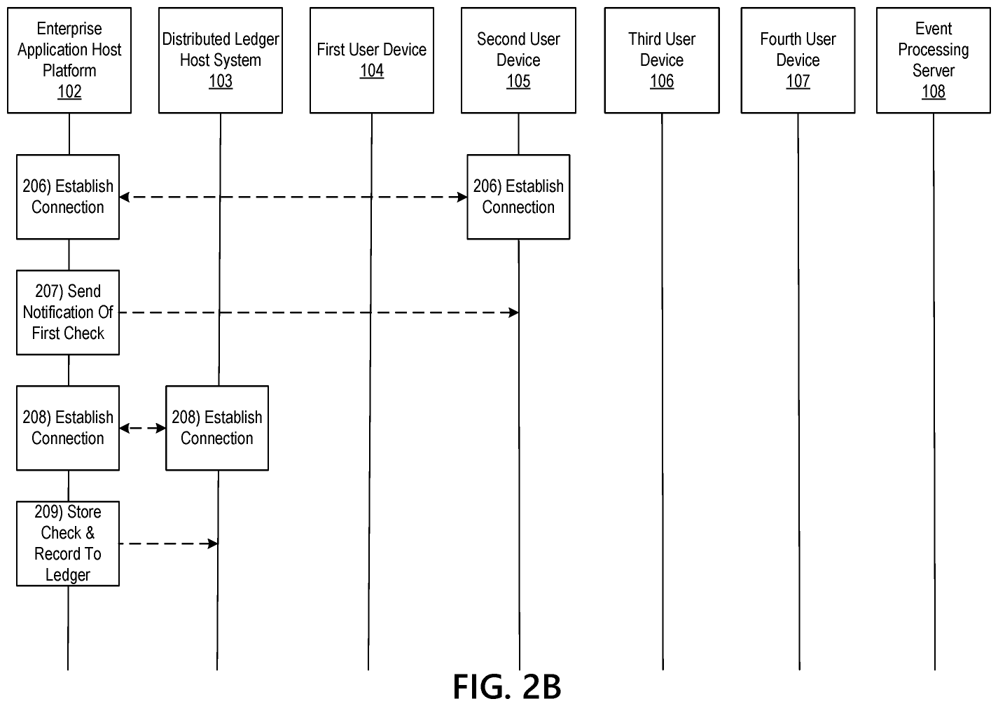

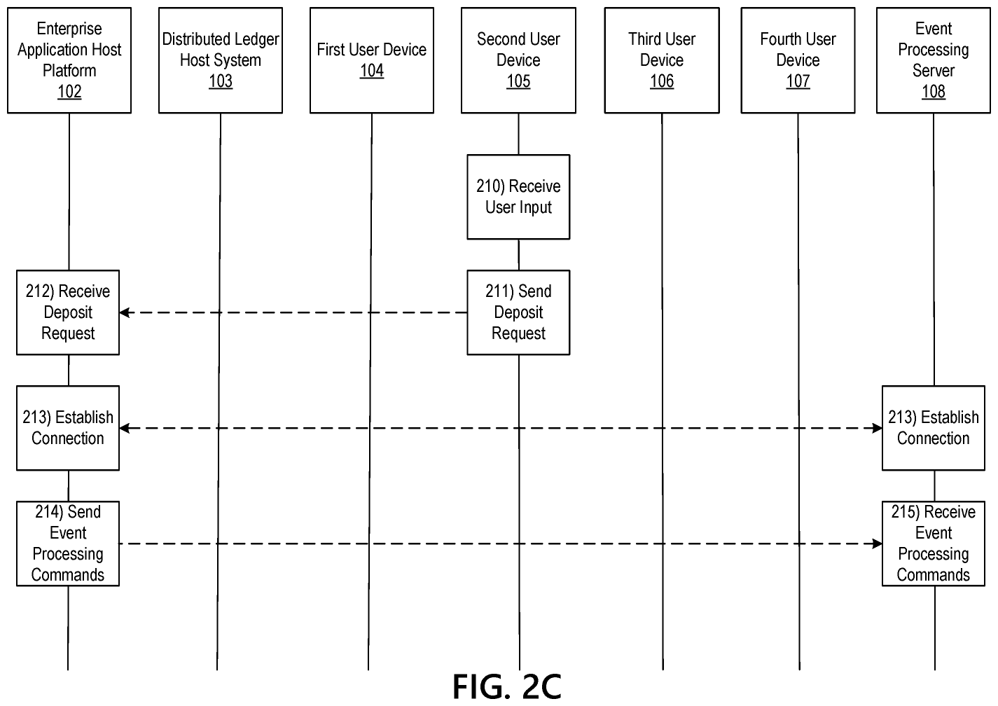

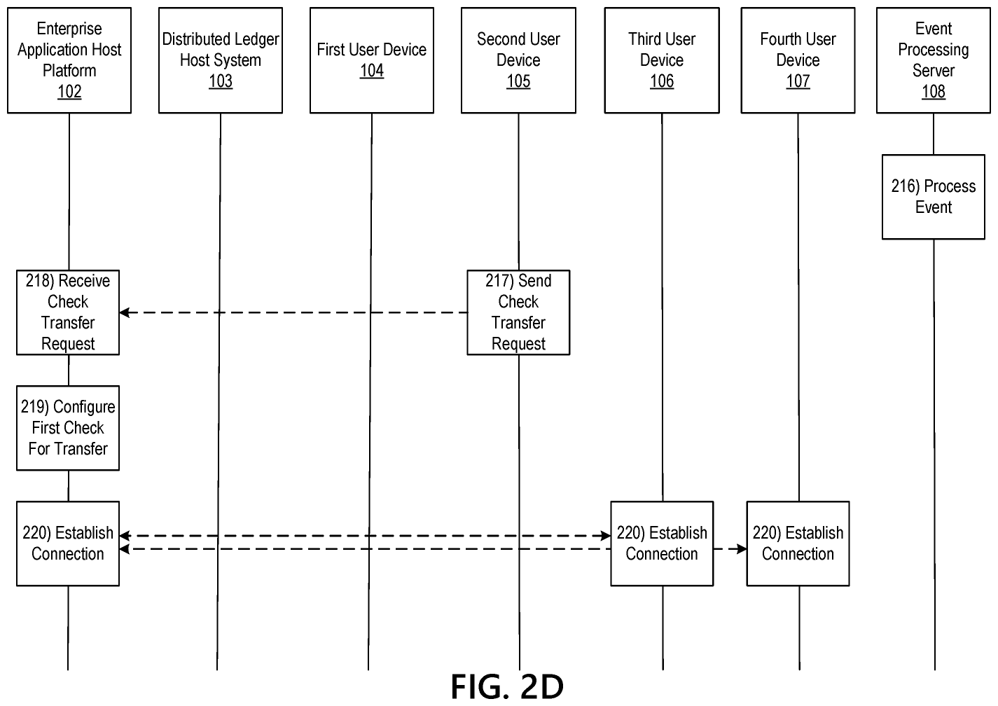

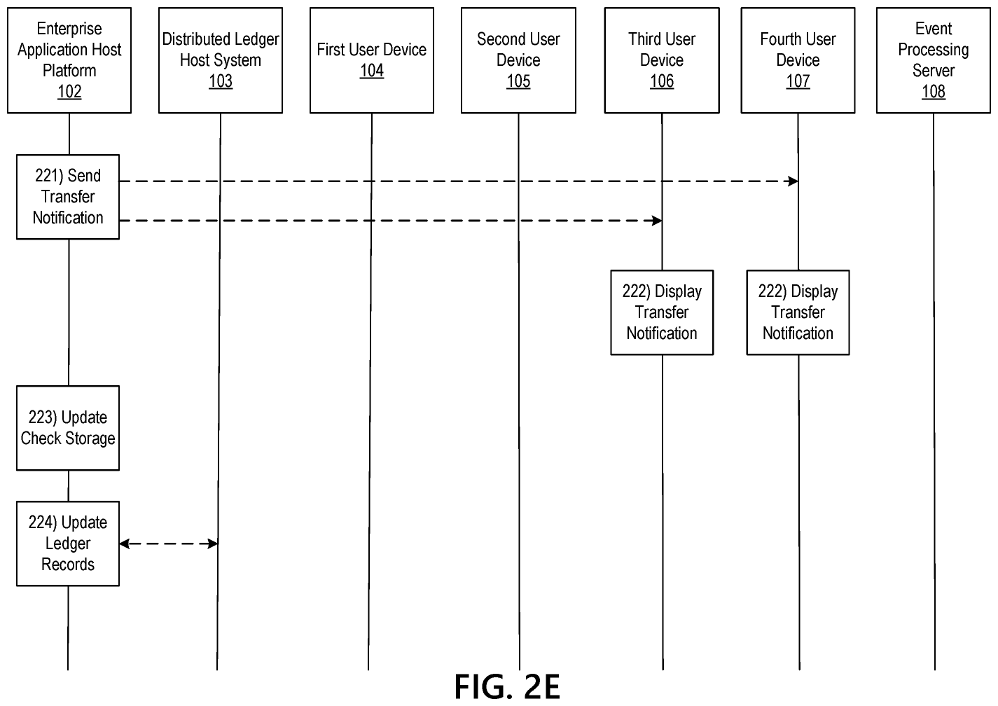

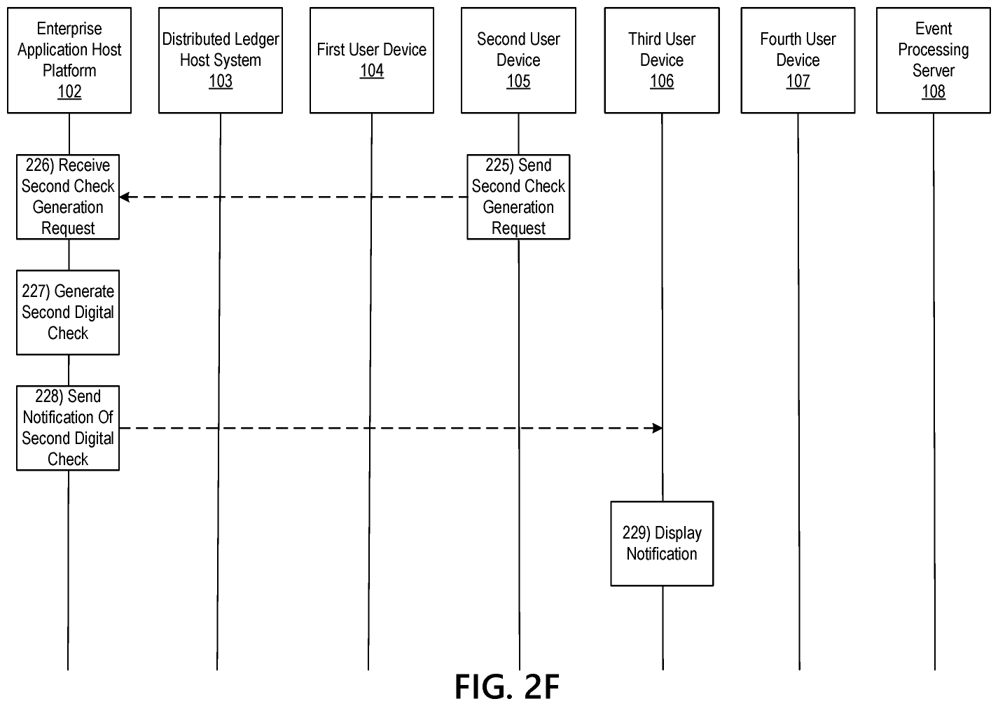

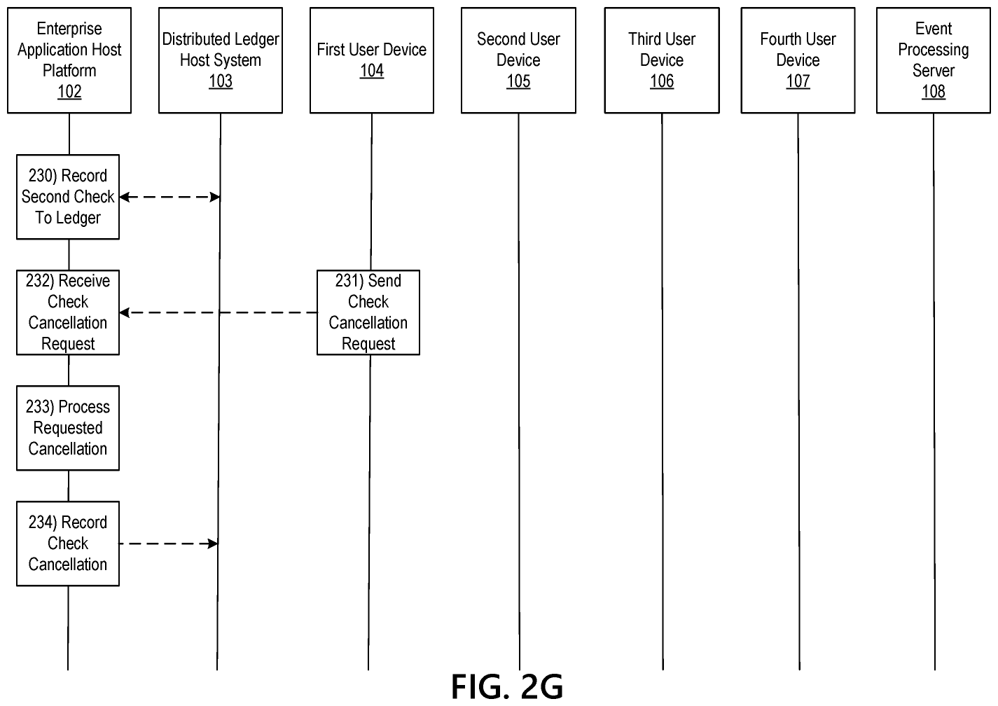

FIGS. 2A-2G depict an illustrative event sequence for performing enhanced digital check generation in accordance with one or more example embodiments. Referring to FIG. 2A, at step 201, the first user device 104 may receive a check generation request via a user interface of the first user device 104. For example, the first user device 104 may receive a user input, via an application such as a mobile banking application, installed at the first user device 104 and/or supported by the enterprise application host platform 102. In some instances, the first user device 104 may receive a request to generate a digital check from one or more accounts (e.g., checking account, savings account, and/or other accounts), which may include a value, a recipient, a payor, and/or other information. In some instances, the recipient may be selected from a friends list included in the mobile banking application, which may include individuals, businesses, and/or other recipients. In doing so, the payor might not need to know account details of the recipient in order to generate the first digital check. In some instances, the first user device 104 may receive user input specifying which of the one or more accounts should be used to create the digital check (e.g., without needing to switch between the one or more accounts to create the digital check). Additionally or alternatively, the first user device 104 may have previously received user input preselecting one or more accounts for use in digital check generation. For example, the first user device 104 may receive user input specifying that digital checks should be generated using funds from a first account (until funds of the first account are depleted, reach an account balance minimum value, and/or otherwise), and then from a second account. In doing so, the first individual may avoid account depletion by receiving a warning or other notification, which may indicate that funds in the first account are depleted or have reached a minimum account balance. In some instances, the user input may identify an appearance of the requested digital check, which may, e.g., depend on a nature of a corresponding transaction (e.g., an individual may have different check backgrounds for business and personal transactions).

At step 202, the first user device 104 may establish a connection with the enterprise application host platform 102. For example, the first user device 104 may establish a first connection with the enterprise application host platform 102 to link the first user device to the enterprise application host platform 102 (e.g., in preparation for sending a first check generation request). In some instances, the first user device 104 may identify whether a connection is already established with the enterprise application host platform 102. If a connection is already established with the enterprise application host platform 102, the first user device 104 might not re-establish the connection. If a connection is not yet established with the enterprise application host platform 102, the first user device 104 may establish the first connection as described herein.

At step 203, the first user device 104 may send the first check generation request, received at step 201, to the enterprise application host platform 102. For example, the first user device 104 may send the first check generation request to the enterprise application host platform 102 while the first connection is established.

At step 204, the enterprise application host platform 102 may receive the first check generation request sent at step 203. For example, the enterprise application host platform 102 may receive the first check image via the communication interface 113 and while the first connection is established.

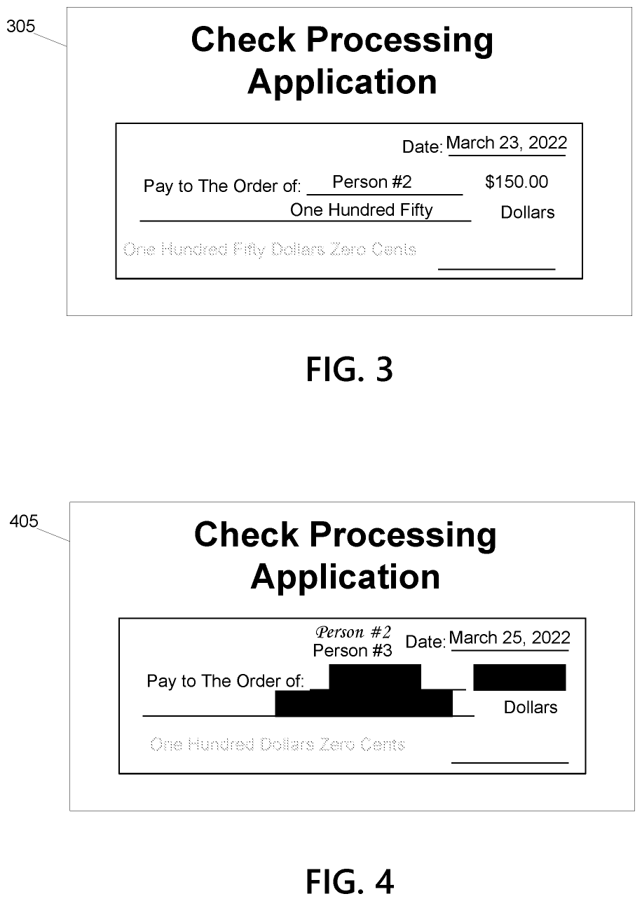

At step 205, the enterprise application host platform 102 may generate a first digital check. For example, the enterprise application host platform 102 may generate a digital check similar to the digital check depicted in graphical user interface 305, which is shown in FIG. 3, and which indicates a check recipient (e.g., Person #2) and a value (e.g., one hundred fifty dollars). As described above at step 201, the value of the first digital check may be tied to one or more accounts of the first individual, and the enterprise application host platform 102 may have one or more stored rules for allocating digital checks based on the one or more accounts. For example, as described above, the enterprise application host platform 102 may store a rule specifying that digital checks should be generated using funds from a first account (until funds of the first account are depleted, reach an account balance minimum value, and/or otherwise), and then from a second account, and so on. In doing so, the enterprise application host platform 102 may effectively and efficiently generate digital checks using multiple sources of funds. Furthermore, in doing so, the enterprise application host platform 102 may generate a digital check that is traceable, able to be cancelled, and/or has additional security benefits.

In some instances, in generating the first digital check, the enterprise application host platform 102 may validate that the one or more accounts of the first individual are sufficient to support the value of the first digital check. If the one or more accounts of the first individual are sufficient, the enterprise application host platform 102 may embed, into the first digital check, a digital chip, watermark, and/or other validation indicator, indicating that the first digital check has been validated. If the one or more accounts of the first individual are not sufficient, the enterprise application host platform 102 might not embed the validation indicator, and might not create the first digital check until additional funds are added to the accounts of the first individual.

Referring to FIG. 2B, at step 206, the enterprise application host platform 102 may establish a connection with the second user device 105. For example, the enterprise application host platform 102 may establish a second connection with the second user device 105 to link the enterprise application host platform 102 to the second user device 105 (e.g., in preparation for sending a notification of the first digital check). In some instances, the enterprise application host platform 102 may identify whether a connection is already established with the second user device 105. If a connection is already established with the second user device 105, the enterprise application host platform 102 might not re-establish the connection. Otherwise, if a connection is not yet established with the second user device 105, the enterprise application host platform 102 may establish the second connection as described herein.

At step 207, the enterprise application host platform 102 may send a notification of the first digital check to the second user device 105. For example, the enterprise application host platform 102 may send the notification of the first digital check to the second user device 105 via the communication interface 113 and while the second connection is established. In some instances, the enterprise application host platform 102 may also send one or more commands directing the second user device 105 to display the notification of the first check, which may, e.g., cause the second user device 105 to display the notification of the first check (which may, e.g., be a graphical user interface depicting the first digital check, similar to graphical user interface 305, as shown in FIG. 3). In some instances, in addition or as an alternative to sending the notification of the first digital check, the enterprise application host platform 102 may granting access permissions, for the second individual, to a distributed ledger for the first digital check (e.g., as described below with regard to step 209).

At step 208, the enterprise application host platform 102 may establish a connection with the distributed ledger host system 103. For example, the enterprise application host platform 102 may establish a third connection with the distributed ledger host system 103 to link the enterprise application host platform 102 with the distributed ledger host system 103 (e.g., in preparation for storing the first check image). In some instances, the enterprise application host platform 102 may identify whether a connection is already established with the distributed ledger host system 103. If a connection is already established with the distributed ledger host system 103, the enterprise application host platform 102 might not re-establish the connection. If a connection is not yet established with the distributed ledger host system 103, the enterprise application host platform 102 may establish the third connection as described herein.

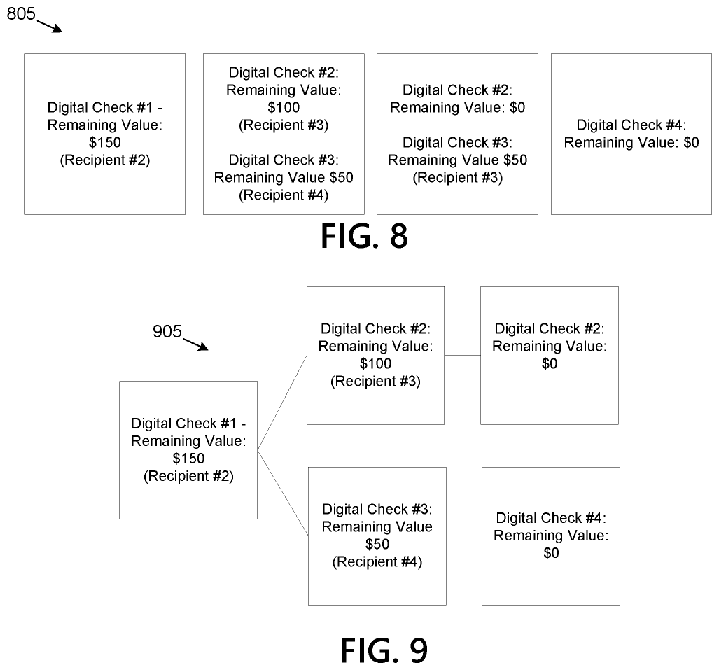

At step 209, the enterprise application host platform 102 and/or distributed ledger host system 103 may store information of the first digital check in memory and/or otherwise in a distributed ledger. For example, for a new check/check image, the enterprise application host platform 102 may create a new chain for a distributed ledger, and may create an initial block in the chain that includes an identity of the initial payor, a recipient, an amount of funds to be transferred, and/or other information (e.g., similar to distributed ledgers 805 and 905, as shown in FIGS. 8 and 9). In some instances, in creating the initial block, the enterprise application host platform 102 may include an indication within the block that the first digital check is validated. In some instances, in storing the first digital check to the distributed ledger, the enterprise application host platform 102 and/or the distributed ledger host system 103 may convert the first digital check to a quick response (QR) code, and may store the QR code to the distributed ledger. In some instances, the distributed ledger may be a blockchain, holochain, and/or other distributed ledger. In some instances, the enterprise application host platform 102 may communicate with the distributed ledger host system 103 via the communication interface 113 and while the second connection is established.

Referring to FIG. 2C, at step 210, the second user device 105 may receive user input requesting an action to be performed with regard to the first digital check. For example, the second user device 105 may receive a request (e.g., via a user interface of the second user device 105) to deposit the amount of funds of the first digital check. In these instances, the event sequence may proceed to step 211. Additionally or alternatively, the second user device 105 may receive a request (e.g., via the user interface of the second user device 105) to transfer the first digital check to another recipient (who may, e.g., be specified using a friends list of a mobile application as described above with regard to generation of the first digital check). In these instances, the event sequence may proceed to step 217. Additionally or alternatively, the second user device may receive (e.g., via the user interface of the second user device 105) a request to generate a new digital check (e.g., using all or a portion of the value of the first digital check), directed to another recipient (who may, e.g., be specified using a friends list of a mobile application as described above with regard to generation of the first digital check). In these instances, the event sequence may proceed to step 225.

At step 211, the second user device 105 may send a request to deposit the first digital check to the enterprise application host platform 102. For example, the second user device 105 may send the request to deposit the first digital check while the second connection is established. In some instances, the second user device 105 may send a request to deposit the first digital check into one or more accounts of the second user (e.g., 50% to a checking account, 50% to a savings account, or the like). In some instances, in sending the request to deposit the first digital check, the second user device 105 may also send endorsement information of the second individual, which may include one or more of: results of a retina scan, a fingerprint, a faceprint, a digital signature, a multi-factor authentication input, and/or other endorsement information.

At step 212, the enterprise application host platform 102 may receive the deposit request sent at step 211. For example, the enterprise application host platform 102 may receive the deposit request via the communication interface 113 and while the second connection is established.

At step 213, the enterprise application host platform 102 may establish a connection with the event processing server 108. For example, the enterprise application host platform 102 may establish a fourth connection with the event processing server 108 to link the enterprise application host platform 102 to the event processing server 108 (e.g., in preparation for sending event processing commands). In some instances, the enterprise application host platform 102 may identify whether a connection is already established with the event processing server 108. If a connection is already established with the event processing server 108, the enterprise application host platform 102 might not re-establish the connection. If a connection is not yet established with the event processing server 108, the enterprise application host platform 102 may establish the fourth connection as described herein.

At step 214, the enterprise application host platform 102 may send one or more event processing commands directing the event processing server 108 to deposit funds, corresponding to the first digital check, from the one or more accounts of the first individual to one or more accounts of the second individual. In some instances, the enterprise application host platform 102 may send the one or more event processing commands to the event processing server 108 via the communication interface and while the fourth connection is established. In some instances, the enterprise application host platform 102 may send the one or more event processing commands after validating endorsement information received from the second user device 105.

In some instances, the enterprise application host platform 102 may automatically send the one or more event processing commands based on generation of the first digital check, which may indicate that the amount of funds of the first digital check should be automatically deposited into the one or more accounts of the second individual (e.g., without any action on behalf of the second individual to deposit the first digital check).

At step 215, the event processing server 108 may receive the event processing commands sent at step 214. For example, the event processing server 108 may receive the event processing commands while the fourth connection is established.

Referring to FIG. 2D, at step 216, based on or in response to the one or more event processing commands received at step 215, the event processing server 108 may deposit the first digital check. For example, the event processing server 108 may execute a transfer of funds from one or more accounts of the first individual to one or more accounts of the second individual. For example, if the first digital check had a value of $150, the event processing server 108 may deposit $150 accordingly. Once the first digital check has been deposited, the event sequence may end.

Returning to step 210, if the user input received indicated a request to transfer the first digital check, the second user device 105 may have proceeded to step 217 (e.g., without performing intervening steps 211-216). Referring now to step 217, the second user device 105 may send a check transfer request, which may, e.g., specify one or more check recipients, corresponding values to be transferred to each recipient, and/or other information. In some instances, the second user device 105 may send the check transfer request to the enterprise application host platform 102 while the second connection is established. In some instances, in sending the request to transfer the first digital check, the second user device 105 may also send endorsement information of the second individual, which may include one or more of: results of a retina scan, a fingerprint, a faceprint, a digital signature, a multi-factor authentication input, and/or other endorsement information.

At step 218, the enterprise application host platform 102 may receive the check transfer request sent at step 217. For example, the enterprise application host platform 102 may receive the check transfer request via the communication interface 113 and while the second connection is established.

At step 219, the enterprise application host platform 102 may configure the first digital check for transfer. In some instances, the enterprise application host platform 102 may configure the first digital check for transfer to a single recipient (e.g., a third individual associated with the third user device 106). In these instances, the enterprise application host platform 102 may modify the first digital check to redact identifying information of a previous payor (e.g., the first individual), and add information of the transferor (e.g., the second individual) and the recipient (e.g., the third individual) on the first digital check. In these instances, because the entire first digital check is being transferred to a single party, a value of the first digital check might not change.

Alternatively, the enterprise application host platform 102 may configure the first digital check for transfer to multiple recipients (e.g., the third individual and a fourth individual associated with the fourth user device 107). In these instances, the enterprise application host platform 102 may redact information of the previous payor and add the transferor/respective recipients as described above. However, in these instances, the enterprise application host platform 102 may configure two versions of the first digital check, one for each recipient. In these instances, the enterprise application host platform 102 may modify a watermark and/or other indicators of the check values. For example, the enterprise application host platform 102 may configure digital checks similar to the digital checks shown in graphical user interface 405 and 505 respectively.

In either instance, the first digital check might not yet have been deposited into one or more accounts of the second individual, and may still be tied to funds of the first individual. Accordingly, deposit of the first digital check may still result in payment from one or more accounts of the first individual, even though the first individual is not the check transferor or otherwise listed on the first digital check. In some instances, prior to configuring the first digital check for transfer, the enterprise application host platform 102 may validate endorsement information received from the second user device 105.

At step 220, the enterprise application host platform 102 may establish a connection with the third user device 106 and/or the fourth user device 107. For example, the enterprise application host platform 102 may establish fourth and/or fifth connections, respectively, with the third user device 106 and/or the fourth user device 107 to link the enterprise application host platform 102 with the third user device 106 and/or the fourth user device 107 (e.g., in preparation for sending check transfer notifications). In some instances, the enterprise application host platform 102 may identify whether connections are already established with the third user device 106 and/or the fourth user device 107. If connections are already established, the enterprise application host platform 102 might not re-establish connections with the third user device 106 and/or fourth user device 107. Otherwise, if connections are not yet established with the third user device 106 and/or the fourth user device 107, the enterprise application host platform 102 may establish the fourth and/or fifth connections as described herein.

Referring to FIG. 2E, at step 221, the enterprise application host platform 102 may send a notification of the check transfer to the third user device 106 and/or fourth user device 107. For example, the enterprise application host platform 102 may send the check transfer notification(s) via the communication interface 113 and while the fourth and/or fifth connections are established. In some instances, the enterprise application host platform 102 may also send one or more commands directing the third user device 106 and/or fourth user device 107 to display the check transfer notification(s). In some instances, in addition or as an alternative to sending the notification of the check transfer, the enterprise application host platform 102 may grant access permissions, for the third and/or fourth individuals, to a distributed ledger for the first digital check (e.g., as described below with regard to step 224).

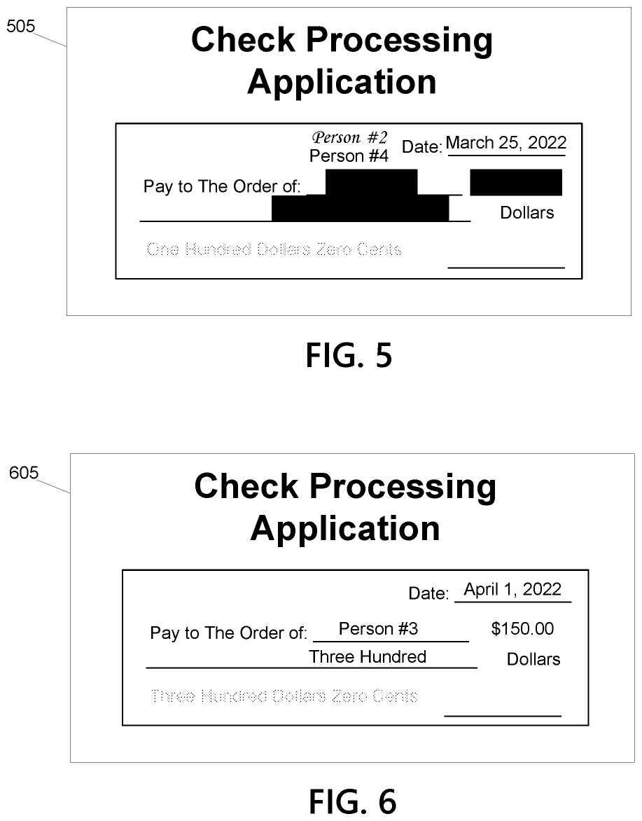

At step 222, based on or in response to the one or more commands directing the third user device 106 and/or the fourth user device 107 to display the check transfer notification(s), the third user device 106 and/or the fourth user device 107 may display the check transfer notification(s). For example, the third user device 106 and/or fourth user device 107 may display graphical user interfaces similar to graphical user interfaces 405 and/or 505, which are shown in FIGS. 4 and 5 respectively.

At step 223, the enterprise application host platform 102 may update its storage and/or memory to reflect the check transfer. For example, the enterprise application host platform 102 may store an indication of the check transfer(s) along with the first digital check (or any versions of the first digital check in the event of a split).

At step 224, in addition or as an alternative to reconfiguring the first digital check for transfer and notifying the third and fourth individuals as described above, the enterprise application host platform 102 may communicate with the distributed ledger host system 103 to record these transfers. For example, the enterprise application host platform 102 and/or distributed ledger host system 103 may modify the distributed ledger to include a second block that includes the transferred check. For example, in the event that the first digital check is transferred to two parties, the enterprise application host platform 102 and/or distributed ledger host system 103 may modify the distributed ledger to include a value of each digital check version and the corresponding recipient (e.g., $100, third recipient account; $50, fourth recipient account, or the like). In some instances, the enterprise application host platform 102 and/or distributed ledger host system 103 may modify the distributed ledger to include a different block for each version of digital check (e.g., a second block for the third individual's version of the first digital check and a third block for the fourth individual's version of the first digital check). In some instances, the enterprise application host platform 102 and/or distributed ledger host system 103 may record the second and third blocks on a single branch of the distributed ledger (e.g., as shown on distributed ledger 805). In other instances, the enterprise application host platform 102 and/or distributed ledger host system 103 may generate separate branches of the distributed ledger, each stemming back to the first block, for each of the second and third blocks (e.g., a different branch corresponding to each version of the first digital check, as shown on distributed ledger 905). In some instances, the enterprise application host platform 102 and/or distributed ledger host system 103 may convert these transferred versions of the first digital check to QR codes, and may store the QR codes to the distributed ledger. In some instances, in modifying the distributed ledger, the enterprise application host platform 102 and/or distributed ledger host system 103 may modify a blockchain, holochain, and/or other distributed ledger.

Returning to step 210, if the user input indicates a request to generate a new digital check, the event sequence may proceed to step 225. In some instances, the event sequence may proceed to step 225 without performing intervening steps 211-224. Referring now to FIG. 2F, at step 225, the second user device 105 may send a request to generate a second digital check. In some instances, the second user device 105 may send a request to generate a second digital check for an amount of funds different than the amount funds of the first digital check (e.g., greater than or less than the value of the first digital check). In some instances, where the requested amount of funds for the second digital check are greater than the amount of funds of the first digital check, the second user device 105 may specify one or more sources of funds for the remaining value (e.g., a savings account, checking account, other digital check, and/or other sources). Additionally or alternatively, the second user device 105 may have preconfigured the one or more sources of funds for use in providing the remaining value. In some instances, the second user device 105 may send the second check generation request before depositing the first digital check. In other instances, the second user device 105 may send the second check generation request after depositing the first digital check. In some instances, the second user device 105 may send the second check generation request to the enterprise application host platform 102. In some instances, in sending the request to generate a second digital check, the second user device 105 may also send endorsement information of the second individual, which may include one or more of: results of a retina scan, a fingerprint, a faceprint, a digital signature, a multi-factor authentication input, and/or other endorsement information. In some instances, the request to generate the second digital check may include physical appearance information for the check, which may, e.g., have been selected by the second individual using a user interface of the second user device, and which may, in some instances, vary based on context of a transaction corresponding to the second digital check (e.g., business, personal, and/or other types of transactions). In some instances, the request to generate the second digital check may be similar to the request to generate the first digital check, which is described above at step 201.

At step 226, the enterprise application host platform 102 may receive the second check generation request, sent at step 225. For example, the enterprise application host platform 102 may receive the second check generation request via the communication interface 113 and while the second connection is established.

At step 227, the enterprise application host platform 102 may generate the second digital check. In some instances, actions performed at step 227 may be similar to those described above at step 205 with regard to generation of the first digital check. However, at step 227, if the requested value of the second digital check exceeds the value of the first digital check, the enterprise application host platform 102 may use one or more other sources of funds (in addition to the first digital check) to support the second digital check. For example, the enterprise application host platform 102 may create a digital check that, when deposited, causes funds of the first digital check to be deposited from the first individual to a recipient of the second digital check (e.g., the third individual), and causes the remaining amount of funds to be pulled from one or more other sources (e.g., one or more accounts, digital checks, and/or other sources of funds corresponding to the second individual). In some instances, as described above with regard to generation of the first digital check, the enterprise application host platform 102 may recieve a selection of which other source should be used to support the second digital check. In these instances, the enterprise application host platform 102 may identify that a balance of an initially selected account of the second individual is zero, or is equal to a preset minimum balance for the initially selected account, and may generate the second digital check based on funds from a different selected account (e.g., which may have been configured as a secondary or otherwise backup account for use in digital check generation) of the one or more accounts of the second individual accordingly.

In other instances, the requested value of the second digital check might not exceed the value of the first digital check. In these instances, the enterprise application host platform 102 may support the second digital check using a portion of the funds corresponding to the first digital check. In these instances, because a remaining portion of the first digital check may be unused, the enterprise application host platform 102 may, in some instances, deposit this remaining portion into one or more accounts of the third individual, or may create a new version of the first digital check, which may be modified to reflect an updated balance on the first digital check. In instances where the first digital check is modified to reflect the new balance, the remaining funds might not be deposited, and advantages of the first digital check (e.g., tracking, cancellation, and/or other advantages) may be maintained. In some instances, prior to generating the second digital check, the enterprise application host platform 102 may validate endorsement information received from the second user device 105.

At step 228, the enterprise application host platform 102 may send a notification of the second digital check to the third user device 106. For example, the enterprise application host platform 102 may send the notification of the second digital check to the third user device 106 via the communication interface 113 and while the fourth connection is established. In some instances, the enterprise application host platform 102 may also send one or more commands directing the third user device 106 to display the notification of the second digital check, which may, e.g., cause the third user device 106 to display the notification of the second digital check. In some instances, in addition or as an alternative to sending the notification of the second digital check, the enterprise application host platform 102 may granting access permissions, for the second individual, to a distributed ledger for the second digital check (e.g., as described below with regard to step 230).

At step 229, based on or in response to the one or more commands directing the third user device 106 to display the notification of the second digital check, the third user device 106 may display the notification of the second digital check. For example, the third user device 106 may display a graphical user interface similar to graphical user interface 605, which is shown in FIG. 6.

Referring to FIG. 2G, at step 230, in addition or as an alternative to notifying the third user device 106 of the second digital check, the enterprise application host platform 102 may communicate with the distributed ledger host system 103 to record and/or otherwise store the second digital check. For example, the enterprise application host platform 102 and/or distributed ledger host system 103 may modify the distributed ledger to include a block that includes the second digital check and/or modified version of the first digital check. For example, the enterprise application host platform 102 and/or distributed ledger host system 103 may modify the distributed ledger to include a value of the second digital check and the corresponding recipient (e.g., $300, third recipient account, or the like) and/or a value/corresponding recipient of the modified version of the first digital check. In some instances, the enterprise application host platform 102 and/or distributed ledger host system 103 may convert these transferred versions of the first digital check to QR codes, and may store the QR codes to the distributed ledger. In some instances, the enterprise application host platform 102 may grant the third user device 106 access to the distributed ledger to view information of the second digital check. In some instances, in modifying the distributed ledger, the enterprise application host platform 102 and/or distributed ledger host system 103 may modify a blockchain, holochain, and/or other distributed ledger. In some instances, the process of generating and sending a new digital check may be complete, and the event sequence may end, or otherwise return to 210 to await additional user input.

At step 231, the first user device 104 may send a check cancellation request, requesting that the first digital check be cancelled and rendered void for purposes of deposit. In some instances, the first user device 104 may send the check cancellation request while the first connection is established. Although the sending of the check cancellation request is shown in steps 231-234 (as described below), this is for illustrative purposes only. These steps may be performed at any point in the above described event sequence without departing from the scope of the disclosure.

At step 232, the enterprise application host platform 102 may receive the check cancellation request, sent at step 231. For example, the enterprise application host platform 102 may receive the check cancellation request via the communication interface 113 and while the first connection is established.

At step 233, the enterprise application host platform 102 may process the requested cancellation. For example, the enterprise application host platform 102 may identify whether or not the first digital check has been deposited. If the first digital check has been deposited, the enterprise application host platform 102 might not proceed with the cancellation (e.g., because the deposit would render such cancellation moot). Otherwise, if the first digital check has not been deposited, the enterprise application host platform 102 may proceed with the cancellation, which may include rendering the first digital check void for purposes of deposit. In doing so, the enterprise application host platform 102 may allow the first individual to effectively recall the funds of the first digital check, which might not otherwise be possible if a different means of electronic transfer were to be performed.

At step 234, the enterprise application host platform 102 may communicate with the distributed ledger host system 103 to record the check cancellation to the distributed ledger. For example, the enterprise application host platform 102 may modify the distributed ledger to include a block indicating that the first digital check has been voided, and that no funds are available corresponding to the first digital check.

Although the use of watermarks, digital chips, and distributed ledgers are described throughout the illustrative event sequence, these methods may be used independently (where the remaining methods may be optional) or in combination with each other without departing from the scope of the disclosure. Furthermore, although four user devices/recipients are described, this is for illustrative purposes only, and any number of user devices/recipient may be involved in the above described methods without departing from the scope of the disclosure.

By using the methods described above, the convenience of generating digital checks from multiple accounts and/or splitting the funds from a check for transfer to multiple parties may be greatly increased. In some instances, this may allow customers to avoid traveling to a physical branch location to execute such transfers. Furthermore, by allowing digital endorsement, multiple parties to checks may provide endorsement regardless of their locations (and even whether or not they are in a common location). Additionally, by allowing transfers in this way, check senders might not need to know account details for a recipient (which may, e.g., be the case if a transfer of funds were otherwise to be performed). Furthermore, by involving the use of distributed ledgers in these methods, the security advantages of an immutable ledger may be achieved in the check transfer process. In addition, in some instances, a transferred check may be recalled or otherwise cancelled (by an individual sending or otherwise transferring the check) prior to being deposited.

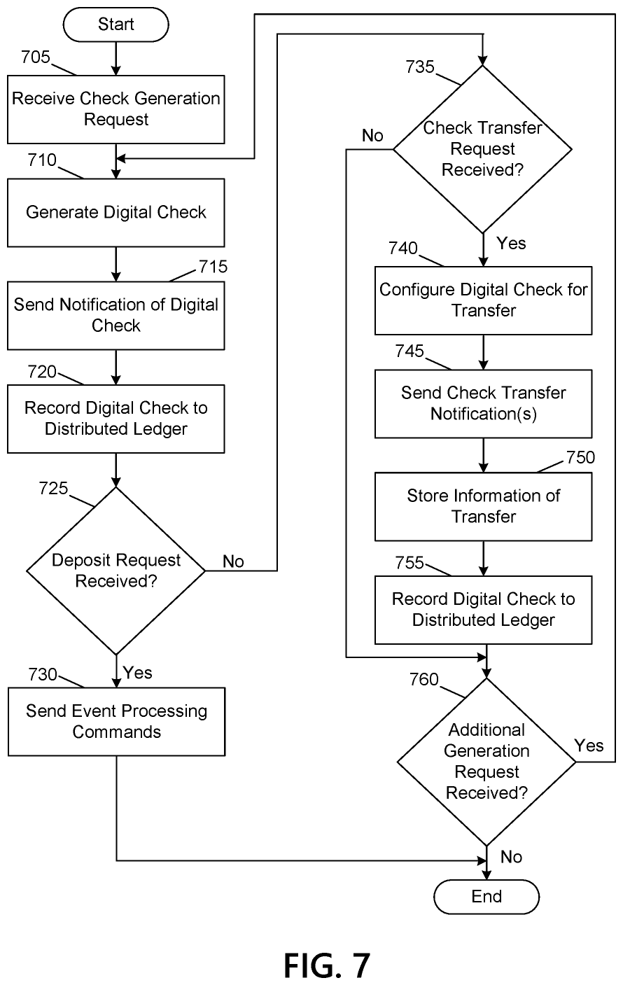

FIG. 7 depicts an illustrative method for enhanced digital check transfers in accordance with one or more example embodiments. Referring to FIG. 7, at step 705, a computing platform including one or more processors, memory, and a communication interface may receive a check generation request. At step 710, the computing platform may generate a digital check. At step 715, the computing platform may send a notification of the digital check to a recipient of the digital check. At step 720, the computing platform may record the digital check to a distributed ledger. At step 725, the computing platform may determine whether a request to deposit the digital check was received. If a deposit request was not received, the computing platform may proceed to step 735. If a deposit request was received, the computing platform may proceed to step 730.

At step 730, the computing platform may send one or more event processing commands, directing an event processing system to execute a deposit of the digital check. Subsequently, once the digital check has been deposited, the method may end.

At step 735, the computing platform may identify whether a request to transfer the digital check is received. If a check transfer request is not received, the computing platform may proceed to step 760. If a check transfer request is received, the computing platform may proceed to step 740.

At step 740, the computing platform may configure the digital check for transfer. At step 745, the computing platform may send a transfer notification to a recipient of the check transfer. At step 750, the computing platform may store information of the transferred check in memory of the computing platform. At step 755, the computing platform may record the transferred digital check to the distributed ledger. At step 760, the computing platform may identify whether an additional check generation request is received. If an additional check generation request is not received, the method may end. Otherwise, if an additional check generation request is received, the computing platform may return to step 710.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive, from a first user device, a digital check generation request, requesting a transfer of a first amount of funds from an account of a first individual to an account of a second individual;
generate, based on the digital check generation request, a first digital check, wherein the first digital check is traceable and configured for cancellation by the first individual prior to deposit;
record the first digital check to a distributed ledger;
send, to a second user device, a notification of the first digital check;
receive, from the second user device, a check processing request requesting one of: a transfer of the first digital check, a deposit of the first digital check, or generation of a second digital check;
based on receiving a request to deposit the first digital check, send, to an event processing system, one or more commands directing the event processing system to transfer the first amount of funds from the account of the first individual to the account of the second individual, wherein sending the one or more commands directing the event processing system to transfer the first amount of funds from the account of the first individual to the account of the second individual causes the event processing system to transfer the first amount of funds from the account of the first individual to the account of the second individual;
based on receiving a request to transfer the first digital check:
configure the first digital check for transfer, wherein configuring the first digital check for transfer comprises redacting information of the first individual from the first digital check and adding a third individual as a recipient of the first digital check, and
send, to a third user device of the third individual, a notification of the transfer of the first digital check; and
based on receiving a request to generate a second digital check:
generate a second digital check, configured to transfer a second amount of funds, from the account of the second individual to the account of the third individual,
send, to the third user device, a notification of the second digital check, and
based on receiving a request to deposit the second digital check, send, to the event processing system, one or more commands directing the event processing system to transfer the second amount of funds from the account of the first individual to the account of the third individual, wherein sending the one or more commands directing the event processing system to transfer the second amount of funds from the account of the first individual to the account of the third individual causes the event processing system to transfer the second amount of funds from the account of the first individual to the account of the third individual.

2. The computing platform of claim 1, wherein generating the first digital check comprises:
validating that an amount of funds in the account of the first individual is equal to or greater than the first amount of funds; and
based on successfully validating that the amount of funds in the account of the first individual is equal to or greater than the first amount of funds, embedding, in the first digital check, digital chip indicating that the first digital check is validated.

3. The computing platform of claim 1, wherein receiving the check processing request comprises receiving endorsement information of the second individual, wherein the endorsement information includes one or more of: results of a retina scan, a fingerprint, a faceprint, a digital signature, or a multi-factor authentication input.

4. The computing platform of claim 1, wherein receiving the request to generate the second digital check comprises a request to generate a check for a greater amount of funds than the first amount of funds, and wherein generating the second digital check is based on the funds of the first digital check and funds of one or more accounts of the second individual.

5. The computing platform of claim 4, wherein the one or more accounts of the second individual are pre-selected.

6. The computing platform of claim 4, wherein the memory stores additional computer-readable instructions that, when executed by the at least one processor, cause the computing platform to:
identify that a balance of an initially selected account of the one or more accounts of the second individual is equal to a preset minimum balance for the initially selected account; and
based on determining that the balance of the initially selected account of the one or more accounts of the second individual is equal to the preset minimum balance for the initially selected account, generate the second digital check based on funds from a different selected account of the one or more accounts of the second individual.

7. The computing platform of claim 4, wherein generating the second digital check based on the funds of the first digital check and funds of the one or more accounts of the second individual comprises generating the second digital check based on:
the funds of the first digital check,
an amount of funds of an initially selected account, equal to a difference between a current balance of the initially selected account and a predetermined minimum balance of the initially selected account, and
an amount of funds of a subsequently selected account, equal to a difference between the second amount of funds for the second digital check and a sum of: the first amount of funds and the amount of funds of the initially selected account.

8. The computing platform of claim 1, wherein receiving the request to generate the second digital check comprises a request to generate a check for a lower amount of funds than the first digital check.

9. The computing platform of claim 8, wherein generating the second digital check comprises:
generating a new check, indicating a transfer of the lower amount of funds from the account of the second individual to the account of the third individual; and
recording, to the distributed ledger, an updated balance of the first digital check, wherein the updated balance comprises a difference between the first amount of funds and the lower amount of funds.

10. The computing platform of claim 1, wherein sending the notification of the first digital check comprises granting access permissions, for the second individual, to the distributed ledger.

11. The computing platform of claim 1, wherein the memory stores additional computer-readable instructions that, when executed by the at least one processor, cause the computing platform to:
receive, from the first user device, a request to cancel the first digital check; and
based on identifying that the first digital check has not been deposited, voiding the first digital check, wherein voiding the first digital check prevents future deposit of the first digital check.

12. The computing platform of claim 1, wherein generating the first digital check comprises, generating, based on funds from at least two accounts of the first individual, the first digital check.

13. A method comprising:
at a computing platform comprising at least one processor, a communication interface, and memory:
receiving, from a first user device, a digital check generation request, requesting a transfer of a first amount of funds from an account of a first individual to an account of a second individual;
generating, based on the digital check generation request, a first digital check, wherein the first digital check is traceable and configured for cancellation by the first individual prior to deposit;
recording the first digital check to a distributed ledger;
sending, to a second user device, a notification of the first digital check;
receiving, from the second user device, a check processing request requesting one of: a transfer of the first digital check, a deposit of the first digital check, or generation of a second digital check;
based on receiving a request to deposit the first digital check, sending, to an event processing system, one or more commands directing the event processing system to transfer the first amount of funds from the account of the first individual to the account of the second individual, wherein sending the one or more commands directing the event processing system to transfer the first amount of funds from the account of the first individual to the account of the second individual causes the event processing system to transfer the first amount of funds from the account of the first individual to the account of the second individual;
based on receiving a request to transfer the first digital check:
configuring the first digital check for transfer, wherein configuring the first digital check for transfer comprises redacting information of the first individual from the first digital check and adding a third individual as a recipient of the first digital check, and
sending, to a third user device of the third individual, a notification of the transfer of the first digital check; and
based on receiving a request to generate a second digital check:
generating a second digital check, configured to transfer a second amount of funds, from the account of the second individual to the account of the third individual,
sending, to the third user device, a notification of the second digital check, and
based on receiving a request to deposit the second digital check, sending, to the event processing system, one or more commands directing the event processing system to transfer the second amount of funds from the account of the first individual to the account of the third individual, wherein sending the one or more commands directing the event processing system to transfer the second amount of funds from the account of the first individual to the account of the third individual causes the event processing system to transfer the second amount of funds from the account of the first individual to the account of the third individual.

14. The method of claim 13, wherein generating the first digital check comprises:
validating that an amount of funds in the account of the first individual is equal to or greater than the first amount of funds; and
based on successfully validating that the amount of funds in the account of the first individual is equal to or greater than the first amount of funds, embedding, in the first digital check, digital chip indicating that the first digital check is validated.

15. The method of claim 13, wherein receiving the check processing request comprises receiving endorsement information of the second individual, wherein the endorsement information includes one or more of: results of a retina scan, a fingerprint, a faceprint, a digital signature, or a multi-factor authentication input.

16. The method of claim 13, wherein receiving the request to generate the second digital check comprises a request to generate a check for a greater amount of funds than the first amount of funds, and wherein generating the second digital check is based on the funds of the first digital check and funds of one or more accounts of the second individual.

17. The method of claim 16, wherein the one or more accounts of the second individual are pre-selected.

18. The method of claim 16, further comprising:
identifying that a balance of an initially selected account of the one or more accounts of the second individual is equal to a preset minimum balance for the initially selected account; and
based on determining that the balance of the initially selected account of the one or more accounts of the second individual is equal to the preset minimum balance for the initially selected account, generating the second digital check based on funds from a different selected account of the one or more accounts of the second individual.

19. The method of claim 16, wherein generating the second digital check based on the funds of the first digital check and funds of the one or more accounts of the second individual comprises generating the second digital check based on:
the funds of the first digital check,
an amount of funds of an initially selected account, equal to a difference between a current balance of the initially selected account and a predetermined minimum balance of the initially selected account, and
an amount of funds of a subsequently selected account, equal to a difference between the second amount of funds for the second digital check and a sum of: the first amount of funds and the amount of funds of the initially selected account.

20. One or more non-transitory computer-readable media storing instructions that, when executed by a computing platform comprising at least one processor, a communication interface, and memory, cause the computing platform to:
receive, from a first user device, a digital check generation request, requesting a transfer of a first amount of funds from an account of a first individual to an account of a second individual;
generate, based on the digital check generation request, a first digital check, wherein the first digital check is traceable and configured for cancellation by the first individual prior to deposit;
record the first digital check to a distributed ledger;
send, to a second user device, a notification of the first digital check;
receive, from the second user device, a check processing request requesting one of: a transfer of the first digital check, a deposit of the first digital check, or generation of a second digital check;
based on receiving a request to deposit the first digital check, send, to an event processing system, one or more commands directing the event processing system to transfer the first amount of funds from the account of the first individual to the account of the second individual, wherein sending the one or more commands directing the event processing system to transfer the first amount of funds from the account of the first individual to the account of the second individual causes the event processing system to transfer the first amount of funds from the account of the first individual to the account of the second individual; and
based on receiving a request to transfer the first digital check:
configure the first digital check for transfer, wherein configuring the first digital check for transfer comprises redacting information of the first individual from the first digital check and adding a third individual as a recipient of the first digital check, and
send, to a third user device of the third individual, a notification of the transfer of the first digital check;
based on receiving a request to generate a second digital check:
generate a second digital check, configured to transfer a second amount of funds, from the account of the second individual to the account of the third individual,
send, to the third user device, a notification of the second digital check, and
based on receiving a request to deposit the second digital check, send, to the event processing system, one or more commands directing the event processing system to transfer the second amount of funds from the account of the first individual to the account of the third individual, wherein sending the one or more commands directing the event processing system to transfer the second amount of funds from the account of the first individual to the account of the third individual causes the event processing system to transfer the second amount of funds from the account of the first individual to the account of the third individual.
